(19) United States
(12) Patent Application Publication
(10) Pub. No.: US 2012/0053893 A1
(43) Pub. Date: Mar. 1, 2012

(54) DEVICE FOR DISPLAYING THE ESTIMATED DRYING TIME OF A COATING COMPOSITION

(75) Inventors: JOHN CHARLES LARSON, West Chester, PA (US); John R. Moore, Lansdale, PA (US)

(73) Assignee: E.I. DU PONT DE NEMOURS AND COMPANY, Wilmington, DE (US)

(21) Appl. No.: 12/862,811

(22) Filed: Aug. 25, 2010

(51) Int. Cl. G04F 10/00

(52) U.S. Cl. 702/176

(57) ABSTRACT

The present disclosure is directed to a device for displaying the estimated drying time of an applied layer of a coating composition that is based on the input of several process variables that can include temperature, humidity, film build, air velocity, altitude, the type of coating composition or a combination thereof. The disclosed device provides an input for one or more of the process variables, a network or algorithm for computing the estimated drying time based on the input process variables, and an output device for displaying the estimated drying time.

### FIELD OF THE DISCLOSURE

The present disclosure is directed to a device for displaying the estimated drying time of an applied layer of a coating composition. The estimated drying time of an applied layer of a coating composition can be a function of several process variables, including the temperature, humidity, film build, air velocity, altitude and the type of coating composition. The disclosed device provides an input for one or more of the process variables, a network or algorithm for computing the estimated drying time based on the input process variables, and an output device for displaying the estimated drying time.

### BACKGROUND OF DISCLOSURE

The coating of substrates is an important industrial process. In an assembly line setting wherein a multitude of the same or similar substrates are coated, the drying time of the applied coating composition is generally a relatively constant and known time period. The design of the manufacturing line takes into account that the coating will be dried within this known time period before the next steps in the manufacturing process can occur.

In processes wherein a multitude of differently sized and shaped substrates are coated, sometimes with more than one type of coating composition, such as, for example, in an automotive refinish setting, the process can be highly variable with respect to the conditions under which the coating is dried. Such variability leads to inefficiencies within the automotive refinish shop. Many refinish facilities are relatively small enterprises having only one or two paint drying booths. The scheduling and flow of work within these refinish shops can be affected if the scheduler incorrectly estimates the drying time of a particular work piece. This in turn can lead to higher costs for both the refinish shop and the customer due to the need to pay overtime to workers, less finished product to turn over to customers and decreased productivity.

### STATEMENT OF THE DISCLOSURE

The present disclosure provides for a device for the prediction of an estimated drying time of an applied layer of coating composition, wherein the device comprises;
A) an input device for entering one or more process variables;
B) a network trained to predict the drying time of the applied layer of coating composition in response to variation in the input process variables; and
C) an output device for displaying the estimated drying time.

### BRIEF DESCRIPTION OF DRAWING

FIG. 1 is a screenshot showing one possible configuration for the input and output device.

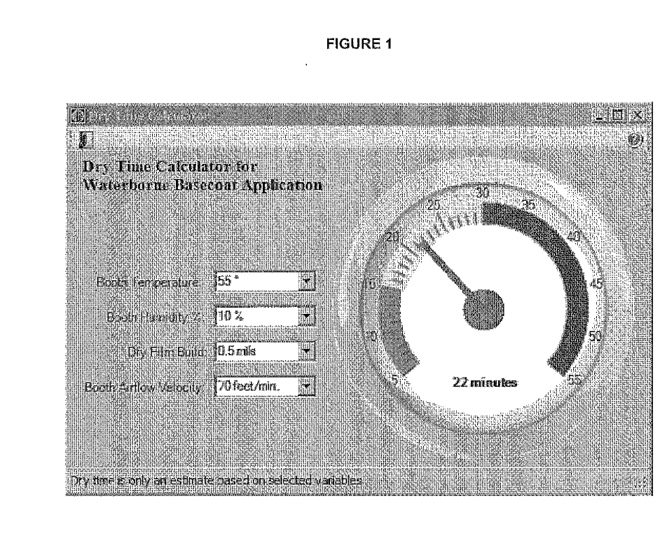

### DETAILED DESCRIPTION

The features and advantages of the present disclosure will be more readily understood, by those of ordinary skill in the art, from reading the following detailed description. It is to be appreciated that certain features of the disclosure, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including every value between the minimum and maximum values.

As used herein:

“Estimated dry time” or “estimated drying time” means an estimated length of time starting when a layer of a coating composition is applied to a substrate and ending when the layer of coating composition has cured to the point where 1) the coating can be further processed without leaving a permanent impression in the coating from being handled; or 2) the substrate can have a second layer of coating composition applied over the first layer without negatively affecting the appearance of either applied coating composition.

The term ‘drying booth’, refers to an enclosure that the coated substrate is placed or allowed to stand during the drying and curing process. The drying booth can be an enclosure that is dedicated only to the drying and curing of a coated substrate, it can be an enclosure that has multiple uses, including, for example, the application of the coating composition as well as the drying and curing of the applied coating composition. In refinish shops that do not have a drying booth, the term drying booth refers to the area that the substrate is placed during the drying and curing of the applied coating composition. The drying booth can be a permanent structure, a temporary structure, or, in some embodiments, the drying booth can be outdoors without any type of structure surrounding the substrate.

The phrase ‘air velocity’ refers to the average speed of an airflow directed toward an applied layer of coating composition. The airflow can be directed at any angle ranging from 0 degrees (parallel) to 90 degrees (perpendicular) to the substrate. Additionally, the air velocity refers to the average air velocity during the entire drying and curing of the applied layer of coating composition.

In some embodiments, the current disclosure relates to a device for estimating the drying time of an applied layer of a coating composition. The device comprises or consists essentially of;
A) an input device for entering one or more process variables;
B) a network trained to predict the drying time of the applied layer of coating composition in response to variation in the input process variables;
C) an output device for displaying the estimated drying time.
   In some embodiments, the device can include a computer that is dedicated to provide only the estimated drying time of an applied layer of a coating composition, or, in other embodiments, the device can include a computer wherein the computer provides other information relevant to an automotive refinish shop, such as, for example, a color matching program that displays a matching paint color formulation based on a target paint color, a vehicle intake program, a scheduling program, a billing program, or a combination thereof. In another embodiment, the device can be a slide rule type device that can provide an output value for the estimated drying time of an applied layer of coating composition.

In some embodiments, the input device can include, for example, a computer mouse that can be used to activate pull-down selection menus and/or graphical slide inputs, the input device can be a computer keyboard for entering a numerical values for the process variables, or the input device can be a combination thereof. In other embodiments, the input device can be a computer touch screen display that allows the user to select the values of the process variables. In still further embodiments, the input device and output device can be displayed on the same graphical interface, such as, for example, a computer monitor.

In some embodiments, the process variables are chosen to be those process variables that have an effect on the drying time of an applied layer of a coating composition. In some embodiments, the process variables can include a temperature input, a humidity input, a film build input, an air velocity input, an altitude input or a combination thereof. These process variables are relatively easily determined in any automotive refinish shop using commonly occurring, inexpensive equipment and can be used to provide an accurate determination of the drying time of an applied layer of a coating composition. In other embodiments, the process variables further include the choice of a solventborne coating composition, a waterborne coating composition or the particular tradename of a coating composition. Each of these process variables can have an effect on the estimated drying time of an applied layer of a coating composition.

The temperature input can be expressed in units of, for example, Fahrenheit, Celsius, Kelvin. In some embodiments, the temperature input refers to the temperature inside the drying booth. In embodiments where a drying booth is not available, the temperature input refers to the temperature of the ambient air in the room that the coated substrate is dried and cured. In some embodiments, the temperature input can include values in the range of from 0° C. to 100° C. In other embodiments, the temperature input can include values in the range of from 20° C. to 90° C.

The humidity input can be, for example, the relative humidity, expressed as a percentage, the absolute humidity, expressed as a quantity of water vapor in a given volume of air, or any other unit that is common in the art. In some embodiments, the humidity input refers to the relative humidity of the air inside the drying booth. In embodiments wherein a drying booth is not available, the humidity input refers to the humidity of the air in the room or space where the coated substrate is dried and cured. In some embodiments, the humidity input can be a relative humidity and include values in the range of from 0 percent to 100 percent, and in other embodiments can include values in the range of from 10 percent to 90 percent.

The film build input can be expressed in terms of, for example, micrometers, mils or any other unit common in the art. In some embodiments, the film build refers to the dry film build which means the thickness of the applied layer of coating composition after the applied layer has been dried and cured. In some embodiments, the film build can include values in the range of from 2.5 micrometers to 250 micrometers. In further embodiments, the film build can include values in the range of from 5 micrometers to 100 micrometers.

The air velocity input can be expressed in units of, for example, feet/minute, feet/second, centimeters/minute, centimeters/second, miles/hour or any other unit that is common in the art. Methods and devices for directing a flow of air onto a substrate are well known in the art. Any of the known methods for directing a flow of air toward a substrate may be used. In some embodiments, the air velocity can include values in the range of from 0 centimeters/second to 500 centimeters/second. In other embodiments, the air velocity can include values in the range of from 10 centimeters/second to 300 centimeters/second.

The altitude input can be expressed in units of, for example, meters above or below sea level, feet above or below sea level or any other unit that is common in the art. In general, the altitude will be a static number that can be input when setting up and configuring the device. In some embodiments, the altitude can include values in the range of from 100 meters below sea level to 2,500 meters above sea level. In still further embodiments, the altitude inputs can include in the range of from sea level to 2,000 meters above sea level.

In some embodiments, the process variables can also include the type of coating composition applied to the substrate. In some embodiments, the choice for this input can be selected from the group consisting of waterborne coating composition, solventborne coating composition, or a specific product tradename.

The device further comprises a network trained to predict the drying time of the applied layer of coating composition in response to variation in the input process variables. In some embodiments, the network can be a neural network. In other embodiments, the network can be a database containing data compiled by actual experiments that replicate the range of all of the input process variables. In some embodiments, it may not be necessary to duplicate each and every process variable, but the data may be extrapolated from a representative sample of actual experiments. In this manner it is useful to conduct a statistically significant number of experiments to provide data that is able to provide an accurate estimation of the drying time to the output device.

Each of the previous process variables can be measured using more than one unit to define the value. In some embodiments, the device can accommodate any desired input unit and the network can contain a program that can convert the given input to one or more of the units that was used when designing the device. As an example, an input air velocity value of feet per second can easily be converted to units of centimeters per second.

The device further comprises an output device. The output device can be a computer screen that displays the estimated drying time, a printer that displays a printout comprising the estimated drying time or a combination thereof. The output device can display the estimated drying time in any format that a user would find easily recognizable. The simplest format can include an output comprising a numerical display indicating the estimated drying time in seconds, minutes or hours. In some embodiments the estimated drying time can be output using a number of various colors indicating to the user optimum drying times for the chosen process variables. As an example, if an input process variable is too high, the estimated drying time can be displayed in a red color indicating that the applied layer of coating composition may not have optimum properties after drying and curing. As another example, if the process variables are chosen so that the applied layer of coating composition will have optimum properties, the estimated drying time can be displayed in a green color.

In another embodiment, the output device can display all of the input process variables so that the user can confirm that all of the process variables are accurate. In a further embodiment, the output device can dynamically display the estimated drying time based on changes to the process variables.

In further embodiments, the device for estimating the drying time of an applied layer of coating composition can be a slide rule device. Such a device can comprise a first member being a planar sleeve defining a passage for the slideable retention of a second member. The first member can have printed thereon, a scale of a first variable corresponding to a first process variable and a scale for the estimated drying time and a window for displaying the desired output. The second member can be a planar member which can be positioned within the sleeve of the first member. The second member can also have printed thereon, a second scale corresponding to a second process variable that defines a means for locating the first variable value and the estimated drying time value provided on the first member. The first and second member are coupled in such a way that the movement of one member with respect to the other member results in identification of the estimated drying time value. Such a device is described in U.S. Pat. No. 5,148,006, to Driscoll, et al., published Sep. 15, 1992. The device described in this patent is for determining the modulus and loss factor of a dampening material based upon the frequency and temperature can be modified to provide the desired estimated drying time output can be modified to provide an estimated drying time output based on two variables as inputs.

In another embodiment, the device can be a manually operable calculator for determining the estimated drying time of an applied layer of a coating composition based on the basis of three variables. The calculator can comprise a sliding member upon which two rotating wheels are mounted on a common axis of rotation. The slide and wheels have indicia printed thereon corresponding to three process variables. The indicia on the wheels can be selected by rotating while the indicia on the slide is selected by moving the slide within a sleeve having openings thereon. Such a device is described in U.S. Pat. No. 5,517,007 to Morgan, et al., published on May 14, 1996. The device described in this patent is used for determining the total storage available for a recording medium such as a hard disk or magneto optical disk based on the input of three variables. Such a device can be modified to provide an estimated drying time output based on the input of three of the previously described variables.

What is claimed is:

1. A device for the prediction of an estimated drying time of an applied layer of coating composition, wherein the device comprises;
A) an input device for entering one or more process variables;
B) a network trained to predict the drying time of the applied layer of coating composition in response to variation in the input process variables;
C) an output device for displaying the estimated drying time.

2. The device of claim 1 wherein the process variable for entering into the input device consist of a temperature input, a humidity input, a film build input, an air velocity input, an altitude input, type of coating composition input or a combination thereof.

3. The device of claim 1 wherein the output device is a computer monitor.

4. The device of claim 1 wherein the input device is a computer mouse.

5. The device of claim 2 wherein
1) the temperature input comprises temperatures in the range of from 0° C. to 100° C.;
2) the humidity input comprises a humidity in the range of from 0 percent to 100 percent humidity;
3) the film build input comprises a film build in the range of from 2.5 micrometers to 250 micrometers;
4) the air velocity input comprises an air velocity in the range of from 0 centimeters/second to 500 centimeters/second;
5) the altitude input comprises an altitude in the range of from 100 meters below sea level to 2,000 meters above sea level; or
5) the type of coating composition input comprises a choice of waterborne coating composition and solventborne coating composition.

6. The device of claim 1 wherein the output device displays the estimated drying time in minutes.

7. The device of claim 6 wherein the estimated drying time output is color coded to display to a user that the estimated drying time is optimal for producing an aesthetically pleasing coating or to warn the user that the estimated drying time is too long to produce an aesthetically pleasing coating.

8. The device of claim 1 wherein the device is a computer wherein the computer further comprises a color matching program, a vehicle intake program, a scheduling program, a billing program and a combination thereof.
